(19) United States
(12) Patent Application Publication
(10) Pub. No.: US 2011/0099084 A1
(43) Pub. Date: Apr. 28, 2011

(54) SYSTEMS AND METHODS FOR MANAGING PATENT LICENSES

(75) Inventors: Lawrence Horn, Bethesda, MD (US); Scott Mladinich, Littleton, CO (US); Lihua Zheng, Millburn, NJ (US)

(73) Assignee: MPEG LA L.L.C., Chevy Chase, MD (US)

(21) Appl. No.: 12/763,928

(22) Filed: Apr. 20, 2010

Related U.S. Application Data
(60) Provisional application No. 61/171,028, filed on Apr. 20, 2009.

(30) Foreign Application Priority Data
Apr. 19, 2010 (US) PCT/US10/31659

(51) Int. Cl. G06Q 30/00

(52) U.S. Cl. 705/26.25

(57) ABSTRACT

A system is provided for managing patent licenses. The system comprises at least one memory including a first memory location for storing a signal representing a plurality of patent licenses available for procurement. The system also comprises at least one network interface for receiving a signal from a user designating at least one of the licenses for procurement. The system furthermore comprises at least one processor for processing a procurement transaction by which the user procures the at least one designated license. The at least one memory further comprises a second memory location for storing a signal representing information pertinent to the procurement transaction including information regarding an identity of the user and information regarding the procured license.

This application claims the benefit of priority in U.S. Provisional Application for Patent No. 61/171,028, filed on Apr. 20, 2009, which is incorporated herein by reference in its entirety.

### FIELD OF THE INVENTION

The present invention relates generally to systems and methods for managing patent licenses, as well as methods for performing tests, particularly in the field of medical diagnostics.

### BACKGROUND OF THE INVENTION

Enormous biomedical discoveries have been made following the completion of the Human Genome Project. The translation of these discoveries into technologies for improving health care has generated a new era of personalized medicine. One important aspect of personalized medicine is preventive care, where early diagnosis may ensure early intervention and thus more efficient disease management. Another important aspect of personalized medicine is the ability to deliver the right medicine to the right patient at the right time, which necessitates a change in drug development strategy from one drug fits all to stratified medicine. In both preventative care and stratified medicine, biomarker-based diagnostic technologies will play a pivotal role. Early diagnosis is made possible by a better understanding of underlying disease mechanisms. For example, mutations in BRAC1 and BRAC2 genes correlate with a high occurrence of breast and ovarian cancer and, therefore, are used as predictive biomarkers. See http://www.myriad.com/products/bracanalysis.php (accessed Apr. 10, 2009). Stratified medicine is possible only when certain patient populations can be reliably identified to be responsive to a certain drug or a certain drug dosage. For example, the U.S. Food and Drug Administration (FDA) recently approved genetic tests for polymorphisms in the genes coding for two enzymes, CYP2C9 and VKORC1, which are useful along with other factors and consideration in determining an optimal starting dose for warfarin therapy. Warfarin is an anti-coagulant drug. See Warfarin label at http://www.fda.gov/cder/foi/label/2007/009218s1051b1v2.pdf (accessed Apr. 10, 2009).

Various aspects of genetic testing and diagnosis may be covered by patents. For example, isolated nucleic acids corresponding to the genes in genetic tests, methods of testing, and reagents and kits for use in testing are sometimes covered by patents. The owners of such patents may elect to license their rights in the patents to others as a means of obtaining financial returns on the research and develop efforts that led to the patented invention. Entities that practice the patented subject matter often take licenses such patents in order to legally perform the tests or diagnostic methods covered by the patents. Examples of such entities include genetic testing laboratories, manufacturers of test kits or test reagents, and genetic test service companies.

In the case of a genetic test involving only one or two patents, or involving only one or two patent owners, traditional, bilateral licensing arrangements may be sufficient to facilitate development, validation, and commercialization of the test. In contrast, many diseases have more complicated mechanisms and engage more, sometimes even dozens of, genes, which may be covered by numerous patents belonging to numerous different entities. For example, there are at least 215 known gene loci related to hearing loss with varying frequency. See http://www.ncbi.nlm.nih.gov/sites/entrez?db=omim (accessed Apr. 10, 2009). Among these loci, at least 46 genes have been linked to hereditary hearing loss. See http://www.ncbi.nlm.nih.gov/bookshelf/br.fcgi?book=gene&part=deafness-overview (accessed Apr. 10, 2009). In the case of a comprehensive genetic diagnosis of hereditary hearing loss, the relevant genetic biomarkers, most of which need to be tested to generate a meaningful and comprehensive result, may be patented by many different entities, creating a patent thicket that threatens to block the development, validation, and commercialization of a comprehensive genetic test for hereditary hearing loss.

Patent thickets like this exist in relation to tests for single diseases or conditions (such as hereditary hearing loss) as well as tests for collections of diseases or conditions. Further more, genetic testing is also accomplished by “whole genome sequencing.” In this technique, the entire genome (i.e., chromosomal and mitochondrial DNA) represented in a patient sample is “sequenced” (i.e., the identity of the DNA base pairs is determined) and from this sequence one may determine whether the patient harbors genetic variations or abnormalities associated with diseases or other medical conditions. Patents claiming compositions of matter or methods of diagnosis relating to any one of these genetic variations or abnormalities could be used to block the practice of the diagnostic method of whole human genome sequencing.

Patent thickets such as these give rise to a need for multiple licensing transactions, and have the potential to impede technology development, validation and commercialization of diagnostic genetic technologies. Notably, in a report generated by a study group under the auspices of the National Research Council (NRC), the lack of independent clinical validation of genetic tests was attributed to limited access to certain gene-based tests as a result of enforcement by patent owners. See http://www.nap.edukatalog.php?record_id=11487 (accessed Apr. 10, 2009).

Furthermore, the variety of genetic tests currently offered by medical diagnostics testing laboratories likely requires that the laboratories negotiate and manage a large and complicated portfolio of traditional, bilateral patent license agreements. With the advent of personalized medicine, more and more diagnostic tests will emerge and existing tests will evolve, making it ever costlier for the laboratories to negotiate and manage all of the individual patent licenses that may be required to legally operate their businesses.

In light of the challenges of patent thickets and the complicated acquisition and management of patent license portfolios, as exemplified in the genetic diagnostic field, it would be desirable to develop a sophisticated system or method for managing patent licenses. The present invention provides innovative, practical, and efficient systems and methods for overcoming these challenges.

### SUMMARY OF THE INVENTION

The present invention achieves this and other objects. According to one embodiment, a system is provided for managing patent licenses. The system comprises at least one memory including a first memory location for storing a signal representing a plurality of patent licenses available for procurement. The system also comprises at least one network interface for receiving a signal from a user designating at least one of the licenses for procurement. The system furthermore comprises at least one processor for processing a procurement transaction by which the user procures the at least one designated license. The at least one memory further comprises a second memory location for storing a signal representing information pertinent to the procurement transaction including information regarding an identity of the user and information regarding the procured license.

Illustratively, the at least one memory further comprises a third memory location for storing information indicating each licensable patent for which a patent license is available. The at least one network interface is also for receiving from a user a signal containing a request to retrieve a list of one or more of the licensable patents. The at least one processor is also for retrieving from the third memory location the list of licensable patents specified in the request and for formatting a signal indicating the retrieved list. The at least one network interface is also for transmitting to the user the formatted signal.

Alternatively, or additionally, the at least one memory further comprises a third memory location for storing information indicating each predetermined license for licensing the licensable patents for particular products. The at least one network interface is also for receiving from a user a signal containing a query specifying a particular product or a particular category of products to be searched. The at least one processor is also for retrieving from the third memory location each predetermined license available for the product or category of products specified in the query and for formatting a signal indicating the retrieved license or licenses. The at least one network interface is also for transmitting to the user the formatted signal.

The at least one memory may also comprise a memory location for storing information regarding payments for procured licenses. At a time for distributing royalties to at least one party, the at least one processor is for retrieving at least part of the information regarding payments for procured licenses for particular patents, and for calculating a royalty to be distributed to a particular one of the at least one parties.

According to another embodiment, a system is provided for managing patent licenses comprising at least one memory comprising a first memory location for storing a signal representing a plurality of patents for which a license is a available. The systems also comprises at least one network interface for receiving from a user a signal designating at least one of the licensable patents. The system furthermore comprises at least one processor for processing a procurement transaction by which the user procures a license for the at least one designated licensable patents. The at least one memory further comprises a second memory location for storing a signal representing information pertinent to the procurement transaction including information regarding an identity of the user and information regarding the procured license.

According to yet another embodiment, a system is provided for managing patent licenses comprising a network interface for transmitting to a server a signal containing a request to retrieve a list of one or more licensable patents for which a license is available. The network interface is also for receiving from the server a formatted signal indicating the list of licensable patents specified in the request. The system also comprises an input/output device for selecting at least one licensable patent listed on the received list for which a user desires to procure a license. The network interface is also for transmitting to the server a signal requesting procurement of a license for the selected at least one licensable patent.

According to a further embodiment, a system for is provided for managing patent licenses comprising a network interface for transmitting to a server a signal containing a query specifying a particular product or a particular category of products to be searched. The network interface is also for receiving from the server a formatted signal indicating each predetermined license available for the product or category of products specified in the query. The system also comprises an input/output device for selecting at least one of the predetermined licenses that a user desires to procure. The network interface is also for transmitting to the server a signal requesting procurement of the selected at least one predetermined licenses.

According to yet a further embodiment, a method is provided for performing a test. A signal is communicated, via a communication network, with a remote server that stores one or more licenses under one or more patents, which licenses are offered for testing samples to determine the presence or absence of at least one composition of matter. A transaction is executed via the communication network with the remote server to obtain one or more licenses under one or more of the patents.

Illustratively, the test is performed as follows. A sample is obtained. The sample is analyzed for the presence or absence of the at least one composition of matter. For instance. the composition of matter can be a biomarker. Further, the sample can illustratively be a bodily sample. The biomarker may be selected from the group consisting of mutations of a gene or a panel of genes, over-expression of a gene or a panel of genes, under-expression of a gene or a panel of genes, alternative production of splice variants of a gene or a panel of genes, gene copy number variants, epigenetic nucleic acid modifications, single nucleotide polymorphisms, chromosomal rearrangements, proteins, lipids, metabolites, a labeled compound, a drug by-product, a cellular physiological phenotype, an organ physiological phenotype, a general physiological phenotype, and an image of a cell, an organ or an individual, and combinations of any of the foregoing.

### BRIEF DESCRIPTION OF THE DRAWINGS

Features and advantages of the invention will be better understood with reference to the drawings.

FIG. 1 is a representation of an infrastructural overview of a management system for patent licenses according to an illustrative embodiment of the invention.

FIG. 2 is a representational overview of functional modules of a management system for patent licenses in relation to infrastructural components according to an illustrative embodiment of the invention.

FIG. 3 is a flow chart illustrating a user account management process according to an illustrative embodiment of the invention.

FIG. 4 is a representation of the generation and maintenance of a database of genetic diagnostics patent licenses according to an illustrative embodiment of the invention.

FIG. 5 is a flow chart illustrating a payment processing process according to an illustrative embodiment of the invention.

FIG. 6 is a flow chart illustrating a royalty allocation process according to an illustrative embodiment of the invention.

FIG. 7 is a representation of the hardware architecture of a computer according to an illustrative embodiment of the invention.

### DETAILED DESCRIPTION OF THE INVENTION

The following detailed description describes illustrative embodiments of the invention. The present invention provides systems and methods for managing patent licenses. In one aspect, the present invention provides a new paradigm of patent licensing whereby prospective licensees may obtain one or more, or a set of, licenses under the corresponding patents that specifically cover one or more, or a set of, particular products that the licensee wishes to make, use or sell. Prospective licensees can easily search and identify licenses of interest in a patent license database that is created and maintained by an independent patent licensing administrator. Illustratively, prospective licensees can use the systems and methods of the present invention to purchase one or more predetermined (or “pre-packaged”) patent licenses that are already included in the database; and they can also use the systems and methods to request that certain patents or patents licenses be included in the database and made available for purchase in the future. In one sense, the present invention gives prospective licensees an option to build a patent license portfolio that is tailored to their own individual needs. In another sense, the present invention requires the independent licensing administrator to maintain a dynamic database of patent licenses from which prospective licensees can build their own portfolio.

In another aspect, the present invention provides automated systems and methods that 1) allow prospective licensees to purchase patent licenses and manage their accounts electronically, and 2) calculate and remit royalties received from the licensees to the respective patent owners or other third parties. The automated systems and methods also account for patent expirations, the introduction of new patents, and the introduction of new products and modifications to existing products, which can alter the subset of patents that are available for license for the respective product.

In the present invention, the database may include a license or set of patent licenses around a particular product, service, or technology so that prospective licensees may purchase the set of licenses in a single transaction. For example, in the case of genetic diagnosis of hereditary hearing loss, the database may include one license or a set of licenses covering various aspects of testing products and methods offered or to be offered in the marketplace for hereditary hearing loss testing. Likewise, in the case of whole human genome sequencing, the database may include one license or a set of licenses covering various aspects, products and methods for whole genome sequencing. In this sense, the present invention can be used as a means to solve patent thicket problems by providing freedom to operate under large numbers of patents; preventing “stacking” royalty issues associated with having to enter into several licenses with different licensors, each bearing its own royalty; reducing licensing transaction costs; avoiding costly infringement litigation; increasing technology development, adoption, commercialization and patient accessibility, and promoting technical information exchange.

In the present invention, licensees may build patent license portfolios tailored to their individual needs without having to negotiate and deal directly with patent owners. Instead, the licensees can utilize the systems and methods of the present invention to avail themselves of the resources and capabilities of a single independent licensing administrator. Likewise, patent owners can license their patents on a widespread basis through the independent licensing administrator, thereby reducing the costs associated with managing a large licensing program on their own. Furthermore, in the present invention, the license transactions are performed electronically, the database of patents and patent licenses is updated periodically to reflect the evolving marketplace and the changing needs of licensors and licensees, and the royalties are collected and allocated to patent owners automatically. In this sense, the present invention simplifies patent license management for both licensees and licensors, especially in fields where patent thickets make traditional licensing unfeasible.

The invention is applicable to patent licenses in any field of technology, including without limitation: life sciences, healthcare, energy, battery technology, environment, consumer electronics, communications, computers, chemistry, manufacturing, e-commerce, education, transportation and software.

The present invention is illustrated below in an application for managing genetic diagnostics patent licenses. Herein, genetic diagnostic patents refer to, without limitation: (1) patents claiming compositions of matter such as isolated nucleic acids which correspond to, without limitation, genes, mutated genes, complementary DNAs, RNAs, small RNAs, piwi-interacting RNAs (“piRNAs”), small interfering RNAs (“siRNAs”), and microRNAs; DNA probes; RNA probes; vectors for gene cloning, gene expression and gene delivery; other nucleic acid-based biomarkers; reagents for use in genetic diagnostic tests; and kits for use in genetic diagnostic tests; (2) patents claiming methods of manufacturing components of genetic diagnostic tests and kits; and (3) patents claiming methods of use, such as methods and processes for performing genetic diagnostic tests, and methods for data storage, retrieval and analysis.

Genetic variations or abnormalities associated with diseases or other medical conditions (“genetic biomarkers”) may include, without limitation, mutations (insertions, deletions, duplications, missense, nonsense, synonymous or any other nucleotide changes) of a gene or a panel of genes, over-expression of a gene (e.g., oncogenes) or a panel of genes, under-expression of a gene or a panel of genes (e.g., tumor suppressor genes such as p53 and RB), alternative production of splice variants of a gene or a panel of genes, gene copy number variants (“CNVs”) (e.g., DNA double minutes), epigenetic nucleic acid modifications (e.g., methylation, acetylation and phosphorylations), single nucleotide polymorphisms (“SNPs”), and chromosomal rearrangements (e.g., inversions, deletions and duplications). The determination of one or more of these genetic biomarkers may be involved in a genetic diagnostic test for a given disease or medical condition.

Patents relating to biomarkers other than genetic biomarkers may he utilized in the present invention, and these include, for example, proteins lipids, metabolites in bodily fluids, a synthetic or radio-labeled compound, a drug by-product, a cellular physiological phenotype, an organ physiological phenotype, a general physiological phenotype, and an image of a cell, an organ or an individual.

In one illustrative embodiment, the invention provides a kind of remote communications, network accessible, electronic genetic diagnostic patent “supermarket.” Prospective licensees can search for licenses relevant to a particular product type (e.g., a heritable disease or other medical condition) much as a supermarket shopper browses an aisle of a supermarket for products of a particular type. Prospective licensees can then examine information pertinent to one or more licenses for the respective product type much in the same way that a supermarket shopper browses the available labels of products of the desired type on the shelves of the relevant aisle. The update of patent licenses to reflect new tests, modified tests, new patents, etc., is analogous to the supermarket manager updating the stocked products on the shelves of the aisles.

### A. System Overview

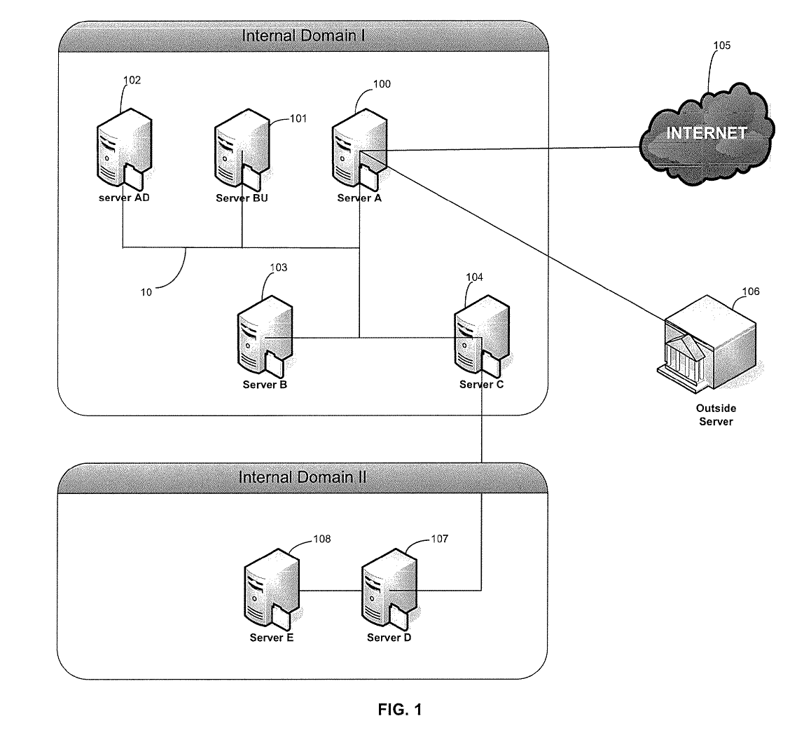

FIG. 1 illustrates an overview of the infrastructure of a patent licensing management system according to an embodiment of the invention. The patent licensing management system may be configured and used with patents of any type. To the extent that illustrative examples are provided herein, they relate to a patent licensing management system for the licensing of genetic diagnostics patents. The management system includes two internal domains called internal domain I and internal domain II. Illustratively, the two domains are operated by, or on behalf of, a licensing administrator. As used herein, a domain refers to one or multiple computers that are accessible via a private network, and/or a publicly accessible wide area network such as the Internet, using an appropriate Internet Protocol (IP) address.

The internal domain I is comprised of the server computers A 100, B 103, C 104, BU 101, and AD 102. These servers 100-104 are preferably connected together by a local area network (e.g., an Ethernet network and/or wireless LAN 10). Server A 100 is connected to the Internet and responds to appropriate requests from remote web browser terminals by serving the front page of a web-based “supermarket”. An example of a web browser terminal is a personal computer, such as the HP® Mini 1000 Mobile Broadband laptop computer, or the HP Compaq® 8000 Elite Ultra-Slim Desktop PC, available from Hewlett-Packard Company®, a company located in Palo Alto, Calif., running an operating system and a web browser program, such as Windows® XP and Internet Explorer®, available from Microsoft Corporation®, a company located in Redmond, Wash. Other examples of web browsing terminals include the iPhone® mobile digital device, the iPad™ mobile digital device, the iPod touch® mobile digital device, and the iMac® computer available from Apple Inc., a company located in Cupertino Calif. Using the remotely connected web browser terminal, a user retrieves the front web page from server A 100 as a starting point to carry out pertinent actions. Server A 100 also stores the user account management system. At times when server A 100 is taken out of service in order to perform maintenance, upgrading or for other reasons, server BU 101 is used to retrieve a signal, e.g. a web page, indicating that server A 100 is currently being serviced. Illustratively, a processor (described in greater detail below) in the server BU 101 responds to requests received from remote web browser terminals by retrieving from its disk memory, main memory or cache memory (described in greater detail below) a signal formatted as a web page indicating that the website is currently being serviced and therefore is unavailable.

Server B 103 stores data related to reported information and the databases for patent information necessary to support the browsing and purchasing functions provided by server A 100. Server C 104 exchanges data with the servers in the internal domain II. Server AD 102 maintains the account information and determines whether a user has the right to access certain parts of the website.

By integrating outside payment services hosted on a remote server 106, server A 100 supports the user interaction with the system by remotely connected users, including, the whole purchase process (with the exception of certain financial purchasing processing that is off-loaded to the outside service server 106, as described below) where licensees obtain rights to certain patents and pay royalties. Upon receiving royalty payments (or an indication that such payments have been made), server A 100 will send licensee reported information to server B 103 for storage. Server A 100 will also, through mediation of server C 104, send licensee report information to the internal domain II for royalty allocation to licensors.

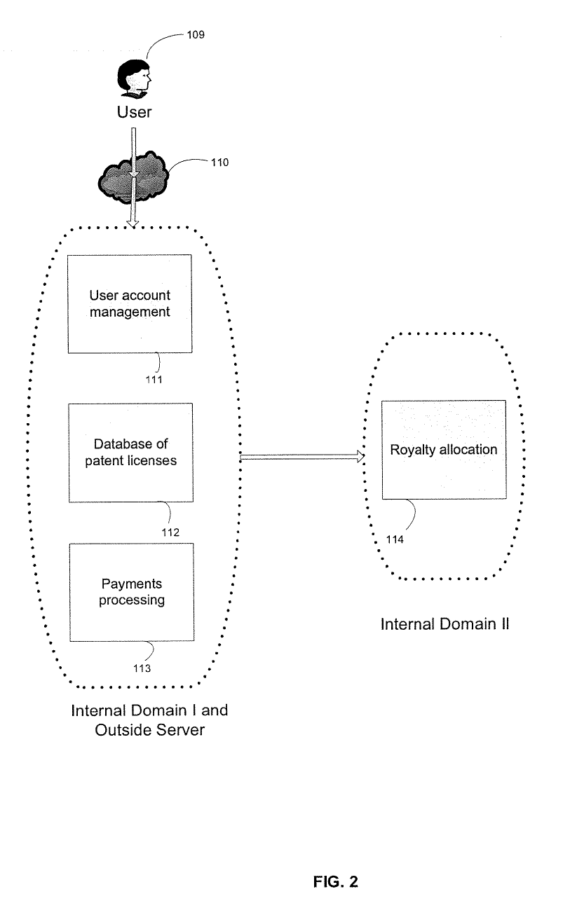

The internal domain II comprises a plurality of server computers such as server D 107 and server E 108. The servers D 107 and E 108 in the internal domain II harbor the royalty allocation module 114 (FIG. 2). In particular, server E 108 maintains the database of patents, owners of the patents and the royalty payment information. The royalty payment information may include information indicating the name of the licensee who made the royalty payment, the product for which the royalty was paid, the license for which the royalty was paid, and the payment rate and amount. The royalty payment information might also include information indicating the country of manufacture of each product (e.g., each test kit), the country of sale for each product (each test kit or test), and/or the country of use of each product (e.g., each test) so that the royalties corresponding to such products can be divided amongst the patents in force in the respective countries.

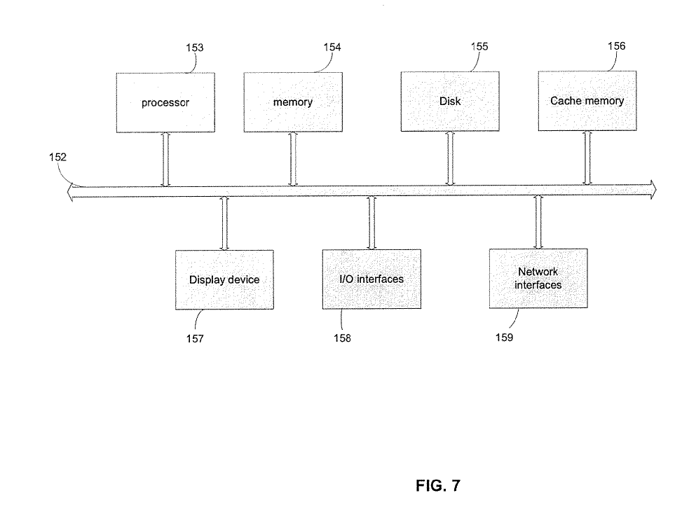

The server computers 100-108 preferably run appropriate software for performing the above-noted functions. An example of a server computer is an HP® ProLiant DL580 G5 Server, distributed by Hewlett Packard Company®, executing Microsoft® Windows Server 2003, distributed by Microsoft Corporation. A computer contains hardware that can interact with human users by receiving electronic signals corresponding to certain instructions from the human users, processing electronic signals in a logical fashion, and outputting results that human users may obtain and interpret for their own use. The basic physical components of a server computer or web browser terminal are described in FIG. 7. A computer typically includes a processor 153 or CPU, a main memory 154, a disk memory 155, a cache memory 156, a display device 157, input/output devices 158, and network interfaces 159. The main memory 154 illustratively is a solid state memory such as a DRAM or SDRAM semiconductor integrated circuit. The cache memory 156 illustratively is also a high speed solid state memory IC such as an SRAM, which is typically smaller than the main memory 154. The disk memory 155 may be a fixed magnetic disk, a removable magnetic disk, a removable optical disk, a removable flash memory (e.g., SD Memory, Memory Stick®, Compact Flash, USB Flash Drive), etc. Memories 154, 155 and 156 have memory locations for storing signals representing information. Illustratively, the disk memory 155 can write a signal representative of information in storage areas thereof persistently, e.g., by permanently magnetizing a storage area of a magnetic disk, by changing the reflectivity of a storage area on an optical disk, by storing electrical charge in a trapped fashion in a flash memory, etc. The input/output devices 158 may be a keypad, virtual keypad or keyboard and a pointer device, such as a mouse, pointing stick, track pad, track ball stylus, or touch screen sensor. The network interfaces 159 may be a modem, a network interface card (e.g., Ethernet NIC), a wireless network card or a circuit (e.g., IEEE 802.11 a/b/g/n interface card, a WiMAX transceiver, a WCDMA transceiver, a CDMA2000 transceiver, a LTE transceiver, etc.), or a Bluetooth communication circuit. Each of these devices is connected via one or more busses 152 to enable communication of signals containing data between the various circuits 153-159. A server computer or a web browser terminal may receive signals from another computer (e.g., a web browser terminal or another server computer) representing requests for information or provided information, perform arithmetic and/or logical computations based on received requests or provided information, store signals derived from or representing the provided information, retrieve requested information and transmit electronic signals containing such requested information, e.g., formatted as web pages.

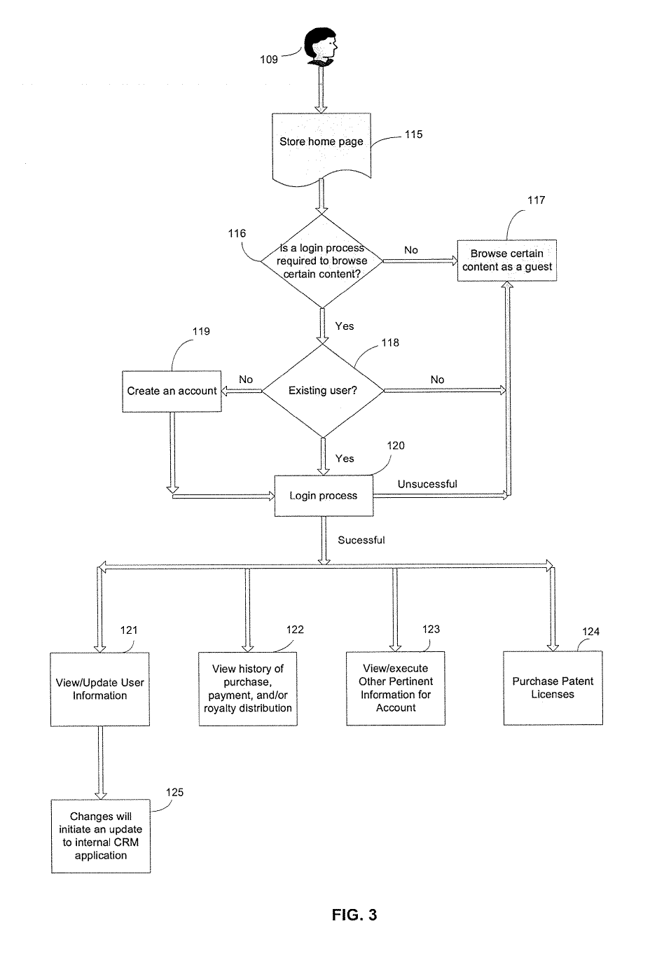

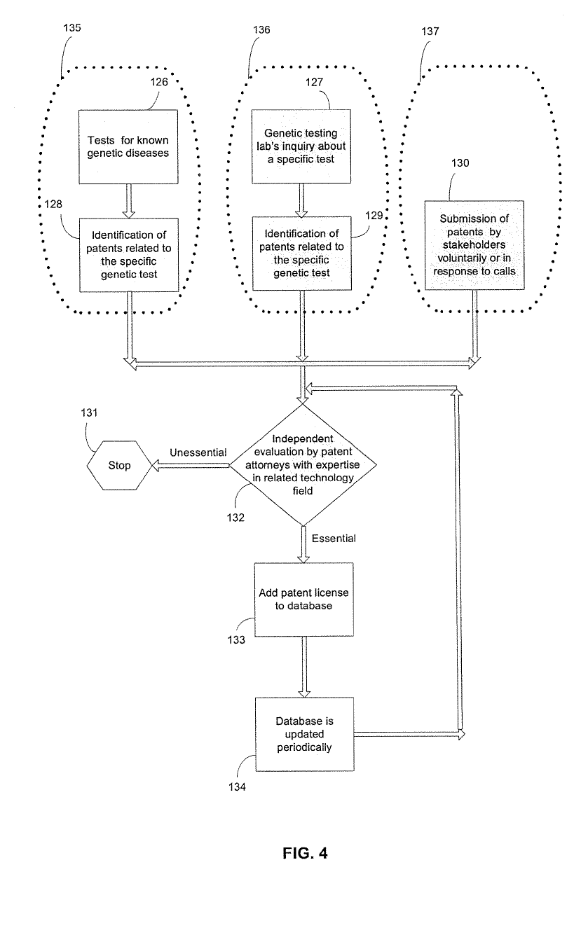

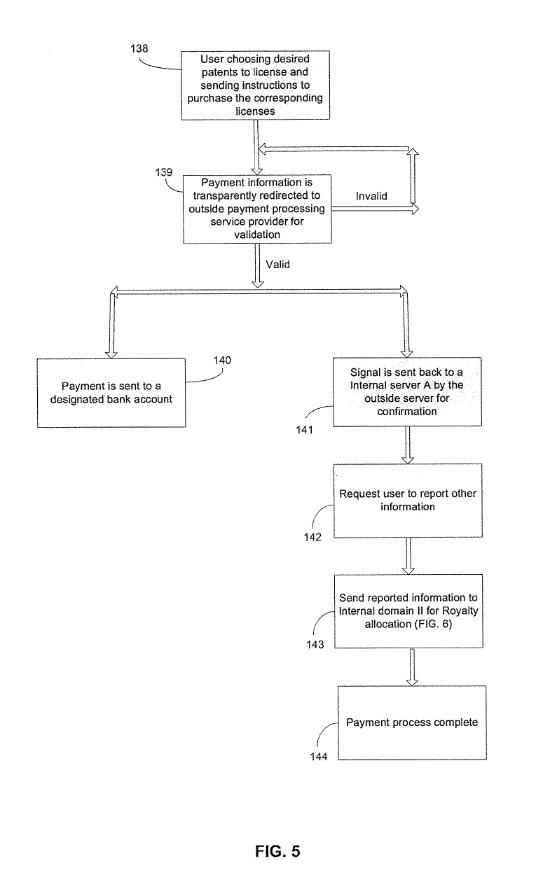

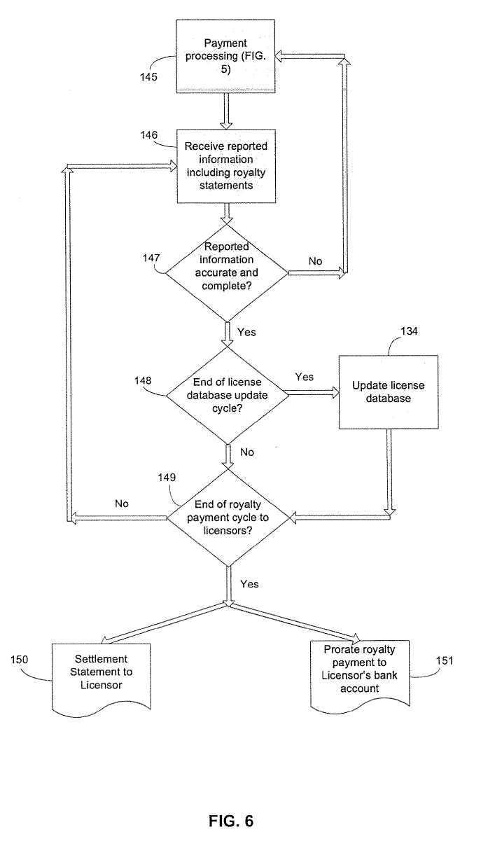

FIG. 2 illustrates the four major functional modules of the management system for patent licenses in this invention. The management system is mainly comprised of four functional modules: a user account management and browsing module 111, a database module 112, a payment processing module 113, and a royalty allocation module 114. The first three modules 111, 112 and 113 are harbored in internal domain I and the fourth module 114 is harbored in internal domain II. These modules are inter-connected and transfer data in a logical and well known manner. The modules may be distributed amongst the servers as follows: servers 107 and 108 harbor the royalty allocation module 114; servers 100-102 harbor the user account management and browsing module; server 103 harbors the database module; and servers 100 and 106 harbor the payment processing module. Each module is described in respective figures in detail: FIG. 3 for user account management, FIG. 4 for the database of patents and patent licenses, FIG. 5 for payment processing, and FIG. 6 for royalty allocation.

### B. User Account Management and Browsing Module

FIG. 3 depicts processing in the user account management and browsing module 111 according to an illustrative embodiment of the invention. Users 109 may be browsers, licensees and/or licensors. Some users may be both a licensee and a licensor since they may both own a patent in, and/or offer a license for, the patent license database (described in FIG. 4) and also obtain license rights under another patent from the database. In a first step 115, a user 109 accesses a home page of the independent licensing administrator stored in server A 100 via the Internet. The access is achieved by the user entering input via the input/output device of the user's web browser terminal, and responsive to such input, the network interface of the user's 109 web browser terminal transmitting a signal containing a request for the home page which is received via the network interface of server A 100. The processor of server A 100 illustratively retrieves from its disk memory, main memory and/or cache memory the “front page” or home page and transmits the home page via its network interface and the Internet to the memory of the user's 109 web browser terminal. Under control of its processor, the web browser terminal can display the front page” on its display device. In a like fashion, the user 109 can, using his or her web browser terminal, attempt to browse other web pages by transmitting signals which are received via the network interface of the server A 100. In step 116, a determination is made by the processor of server A 100 as to whether the type of browsing that the user wants to perform requires a login process. If not, in step 117, the processor of server A 100 permits the user to browse as a guest. If login is required, the processor of server A 100 determines in step 118 whether the user 109 has an existing account. For example, the processor of server A 100 can transmit a request for information identifying the user 109 to the user's 109 web browser terminal. Such a request is displayed on the web browser terminal's display. The user can input a reply using the web browser terminal's input/output device. Then, the user 109 can send appropriate information via his or her web browser terminal to the processor of the server A 100. This may be achieved by appropriate input to the input/output devices of the web terminal which causes the network interface of the user's web browser terminal to transmit a signal containing the appropriate information. The processor and network interface in server A 100 may communicate with the network interface and processor of server AD 102 which accesses the user account database stored in the disk memory, main memory or cache memory of sever AD 102 during this step 116. If the user does not already have an account, the processor in the server A 100 retrieves from its disk memory, main memory and/or cache memory, and transmits via its network interface, the appropriate web page for generating a new account. The processor of the server A 100 may receive appropriate input from the input/output devices and network interface of the user's 109 web browser terminal to enable the user to create an account in step 119. If the user 109 creates an account successfully, the account information is transferred from the processor of server A 100 to the server AD 102 where it is stored in a disk memory, main memory and/or cache memory therein. If the user fails to create an account or chooses not to create an account, the processor in the server A 100 executes step 117 according to which the user 109 browses as a guest. If the user already has an account or just created a new account, the processor in the server A 100 performs the login process in step 120. An unsuccessful login process will cause the processor in the server A 100 to lead the user to browse the site as a guest in step 117. If the login is successful, the processor in the server A 100 will allow the user to perform registered user-privileged activities.

In step 117, the server A 100 retrieves from its disk memory, main memory and/or cache memory, and transfers (e.g., using its network interface and the Internet), web pages for guest activities to the user's 109 web browser terminal. An example of a web page for guest activity enables the user 109 to search the database of available licenses, the patents available for license, information indicating the claimed subject matter of each patent, lists of licensees, and/or press releases. In the case of searching for available licenses, the user 109 illustratively can enter at his or her web browser terminal, using the input/output device thereof, a query that specifies a certain product or category of products. In the case of licenses for genetic diagnostic tests, the user 109 can enter at his or her web browser terminal search criteria pertinent to a specific disease or other medical condition of interest. Such search queries are transmitted from the network interface of the user's web browser terminal via the Internet and the network interface at the server A 100 to its processor. In the case of a product category license query, the processor of the server A 100 responds by retrieving from its disk memory, main memory and/or cache memory licenses available for the specified product category, for example, licenses (if any) available for tests related to the user query identified disease. The processor of the server A 100 formats a web page containing such retrieved information and transmits it via its network interface and the Internet to the user's 109 web browser terminal via the network interfaces of the server A, the Internet and the network interface of the user's web browser terminal. In a sense, the act of the user 109 submitting a query specifying a disease is analogous to a user visiting a specific aisle in a supermarket to view available products in the respective category of interest. The retrieved license or licenses for the disease of interest and related tests are analogous to related products on a shelf of the supermarket. The user 109 can browse the returned information (using the web browser terminal's display device). Then, the user 109 can request (e.g., using the web browser terminal input/output device and network interface), and the processor of the server A 100 can retrieve from its disk memory, main memory and/or cache memory, the list of patents included in each of the available licenses. The processor of server A100 formats a web page containing such retrieved information (i.e., the patent lists) and transmits it via its network interface and the Internet to the user's 109 web browser terminal.

In a more sophisticated search environment, the user 109 can also search for, and the processor of the server A 100 can retrieve, from its disk memory, main memory and/or cache memory, other patents of interest. This is useful in the case in which the licensing administrator has the right to license the patents for non-accredited or non-government approved tests, e.g., for tests under development. This facilitates the ability of a research laboratory or university to obtain the requisite patent licenses it needs to develop a new test, thereby stimulating the development of advanced diagnosis and treatments.

In another variation in which the licensing administrator has the ability to license patents on a test component basis, the user can search for, and the server A 100 provides, information indicating which patents cover specific test components, for example, a collection of genes or gene variants for a new genetic diagnostic test. In this scenario, the user 109 queries the particular genes of interest. If there is no predetermined license bundle available for the genes of interest, the system would enable the user 109 to collect together the licensable patents covering each gene component. The user 109 could then purchase in a single license or a series of licenses rights to the assembled patents. Thus, the user 109 could create his or her custom-made license portfolio.

Yet another variation would enable the user 109 to query and view a site-wide license to all patents available for licensing by the independent license administrator. A site-wide license such as this might be of interest to basic researchers and entities engaged in diagnostic genetics based on whole genome sequencing.

Steps 121-124 of FIG. 3 represent processes carried out by the processor of the server A 100 in performing registered user-privileged activities, including at least: 1) viewing and updating user information 121 such as contact information, mailing address and bank account information, which changes will initiate an update to an internal customer relations management (CRM) application 125; 2) viewing histories of purchase, payment, and/or royalty distribution 122; 3) viewing or executing other pertinent account information 123; and 4) purchasing patent license rights 124, preferably on a non-exclusive basis.

Among other things, in process 121, the processor of the server A 100 retrieves from its disk memory, main memory and/or cache memory (for transfer via its network interface to the user's 109 web browser terminal) a web page that enables the user to download from the server A 100 appropriate tax forms. Likewise, the user 109 can transmit from its web browser terminal via the Internet to the processor of the server A 100 (via the network interface) completed tax form information. Often, users 109 who are licensees are required to pay taxes of different kinds on royalties transferred to third parties, for example, expatriation taxes when money is converted from one currency to another. Generally, such taxes are an extra burden on the licensee and are not borne by the licensing administrator or the patent owners. The tax forms among other things provide information that the licensing administrator can use to negotiate lower taxes on behalf of the licensees to reduce their tax burden.

### C. Database Module

FIG. 4 shows a flow chart representing a process for the generation and maintenance of databases of patents for genetic diagnostics according to an embodiment of the invention. The example in FIG. 4 is based on a database of genetic diagnostic patents; however, the illustrated systems and methods may be adapted and applied to the generation and maintenance of databases for other subject areas and patents. Patents that claim subject matter involved in a genetic diagnostic test illustratively are included in the database. Information related to the patents also may be recorded in the database, including, for example, claimed subject matter, expiration dates, patent maintenance fees, annuities, office actions (in the case of pending patent applications maintained in the database), patent owners, current licensees, the related genetic diagnostic tests, validity of the tests (e.g., whether the test would generate results as expected), utility of the tests (e.g., whether the test result would lead to a better treatment), and providers of the test. The database is physically harbored in server B 103.

Candidate patents for the database may be identified from various sources, e.g., a “store” source 135, a customer source 136, and an owner source 137. The term “store” herein refers to a purchasing system for patent licenses operated by an independent patent licensing administrator, as disclosed in the present invention. The term “customer” herein refers to a prospective licensee of patents offered by the licensing administrator using the store. The term “owner” refers to the entities that own or possess the right to allow the licensing administrator to offer licenses for patents using the store.

In the case of a store source 135, tests for known genetic diseases are identified in process 126 based on regulatory standards (e.g., government approved tests) or de facto standards (e.g. medical society endorsed or commercially popular tests). The tests are generally of good clinical validity and utility. The tests may help to diagnose a genetic disease, or elucidate a genetic profile, so that a better or more effective treatment plan may be provided to a patient. In particular the tests may identify one or more genetic biomarkers that are associated with a medical condition or disease. Examples of the range of applicable genetic biomarkers are described above. These tests may be identified from academic and industry publications. Once genetic tests are identified, related technologies are analyzed and patent searches performed to reveal any patents that may be required or desired to practice the tests 128. These associated patents are candidate patents for the database.

As an example of obtaining candidate patents for a store source, a known genetic test was identified for Lynch Syndrome, a hereditary predisposition to certain forms of cancer, predominantly colorectal cancer. Colorectal cancer is the second leading cause of cancer deaths in North America. In 2004, around 150,000 people were diagnosed with colorectal cancer and about 60,000 people died from the disease. See http://www.cdc.gov/cancer/Colorectal/statistics (accessed Apr. 10, 2009). The prognosis for patients with colorectal cancer is directly related to the stage of the cancer at diagnosis, e.g., patients diagnosed with stage I cancer have a 5-year survival rate of greater than 90%, while patients diagnosed with more advanced stages of the cancer, such as metastatic, have a 5-year survival rate of less than 5%. See Ford and Whittemore, “Predicting and Preventing Hereditary Colorectal Cancer,” JAMA, 2006, 296(12):1521-1523. So early diagnosis is essential for minimizing the morbidity and mortality associated with colorectal cancer. While most colorectal cancers are sporadic, 3% of diagnosed cases are hereditary predisposed forms known as Lynch syndrome. Lynch syndrome is manifested by an increased risk of hereditary non-polyposis colorectal cancer (HNPCC), endometrial cancer, stomach cancer, ovarian cancer, etc. Molecular testing has been accepted as a basis for the diagnosis of Lynch syndrome. See JAMA, 2006, 296(12):1507-1517. Lynch syndrome is associated with inherited mutations in genes that encode protein components of DNA mismatch repair complexes. Individuals with one of the inherited mutations have an increased risk of 80% for colon cancer, 40% for endometrial cancer, 15% for stomach cancer, and 10% for ovarian cancer by age 70. See www.genetests.org (accessed Apr. 10, 2009).

Lynch syndrome is diagnosed mainly on the presence of one or more mutations in the following seven genes: MSH2, MLH1, PMS2, MSH6, PMS1, TGFBR2 and MLH3. See http://www.ncbi.nlm.nih.gov/entrez/dispomim.cgi?id=120435 (accessed Apr. 10, 2009). Mutations in MSH2, MLH1, PMS2 and MSH6 account for the majority of the diagnosed cases, while mutations in the other genes are much less common. Indeed, several studies show that mutations leading to Lynch syndrome are distributed as 39% MSH2, 32% MLH1, 15% PMS2 and 14% MSH6. See Palomaki et al., “EGAPP supplementary evidence review: DNA testing strategies aimed at reducing morbidity and mortality from Lynch syndrome,” Genet Med 2009; 11:42-65. The mutations are inherited in an autosomal dominant manner in that offspring of a family member found to have a mutation linked to Lynch syndrome have a 50% chance of inheriting the mutation. Thus, relatives of a person with Lynch syndrome will be at a higher risk of inheriting the associated mutation and therefore at higher risk of having Lynch syndrome. Genetic tests identifying the mutations underlying Lynch syndrome not only serve a diagnostic purpose for patients, but also benefit the patients' relatives in terms of early risk assessment. Early risk assessment usually leads to changes in health management that can improve clinical outcomes, resulting in a reduction of risk for colorectal cancer by as much as 62%. In fact, the Centers for Disease Control and Prevention's (CDC's) Evaluation of Genomic Applications in Practice and Prevention (EGAPP) working group recommends that health care professionals offer genetic testing for Lynch syndrome to both colorectal cancer patients and to relatives of positively diagnosed patients for early risk assessment. The EGAPP working group has not, as yet, recommended a specific testing strategy. See EGAPP Working group, “Recommendations from the EGAPP Working Group: genetic testing strategies in newly diagnosed individuals with colorectal cancer aimed at reducing morbidity and mortality from Lynch syndrome in relatives,” Genetics in Medicine, 2009, 11(1):35-41.

Based on the test schemes offered by most companies and hospital labs, the current de facto standard for genetic diagnosis of Lynch syndrome tests for mutations in MSH2, MLH1 and MSH6, although more genes, such as the PMS2 gene, are expected to be incorporated into the standard in the future. In the US, there are at least ten companies or hospital labs offering genetic tests for the MSH2 gene alone. See details at http://www.genetests.org/servlet/access?prg=j&db=genetests&site=gt&id=8888890&fcn=c&qry=316511&res=&key=NdQABKi7kuAOa&show_flag=c (accessed Apr. 10, 2009).

Examination of the patent landscape surrounding the seven genes associated with Lynch syndrome, namely MSH2, MLH1, PMS2, MSH6, PMS1, TGFBR2 and MLH3, revealed that more than a dozen candidate patents and published applications are directed to the genes and/or methods of using these genes in diagnosis. These candidate patents and applications arc assigned to nearly a dozen different entities.

The present invention with a patent license database that aggregates and bundles patents associated with genetic testing for Lynch Syndrome can simplify the licensing scheme and reduce the costs associated with providing commercial tests. Secondly, reduced costs may make it possible for more labs or companies to offer the test, thereby increasing availability to consumers and competition among suppliers, driving costs down, and improving test quality. Finally, the database that includes the Lynch syndrome patents would be dynamic, making it easier to assimilate new patents as the test evolves, and eliminate old, expired or invalid patents.

The results obtained from testing for Lynch Syndrome help doctors make beneficial decisions for their patients. An exemplary test for genetic biomarkers associated with Lynch syndrome may be performed as follows.
1) A test subject such as a patient sees his/her doctor for a consultation on whether he/she has an increased risk of having Lynch syndrome. The doctor collects the subject's medical histories and/or his/her family history, and then may prescribe for the subject a genetic test for Lynch syndrome risk assessment.
2) A sample containing nucleic acids from the subject is obtained. The sample can be any nucleic acid-containing sample, preferably a bodily sample, including, but not limited to, blood, plasma, serum, urine, sputum, spinal fluid, pleural fluid, nipple aspirates, lymph fluid, fluid of the respiratory, intestinal, and genitourinary tracts, tear fluid, saliva, breast milk, fluid from the lymphatic system, semen, cerebrospinal fluid, intra-organ system fluid, ascitic fluid, tumor cyst fluid, amniotic fluid, biopsy tissue, bone marrow, hair follicle, epithelial cells (e.g., from a cheek swab), or any combinations thereof.
3) The sample is sent to a clinical test lab. At some point before processing the sample, the lab personnel may check to see if the lab has or requires a patent license to run the test. If a license is not required, or if the necessary license is in place, then the sample will be processed as described below in step 4). If a necessary license is not in place, the lab personnel or one of his/her colleagues goes to a web browser interface that connects to a patent license management system as described in this invention and “shops” for all necessary licenses. For instance, the personnel may communicate via a communication network a signal with a remote server that stores one or more licenses under one or more patents, which licenses are offered for testing samples to determine the presence or absence of a genetic biomarkers associated with Lynch syndrome, and then execute a transaction via the communication network with the remote server to obtain one or more of the licenses under one or more of the patents, which licenses are offered for testing a sample to determine the presence or absence of genetic biomarkers associated with Lynch Syndrome. Once the necessary steps are completed, the lab will have the permission to perform the test as described in steps 4 and 5).
4) The sample is processed, e.g., nucleic acids in the sample are extracted for further analysis. Methods of extracting nucleic acids are well known in the art. Some of the methods employ organic solvents, such as phenol and/or chloroform, to selectively precipitate and then remove proteins from a nucleic acid-containing solution. Once the protein is removed, dissolved nucleic acid can be precipitated using alcohol and collected on a solid surface. An appropriate buffer may be was used to solubilize the nucleic acid and thereby remove it from the solid surface. See for example, U.S. Pat. No. 4,908,318. An improved method using Proteinase K for quick DNA extraction from certain downstream reactions such as a Polymerase Chain Reaction (“PCR”) is described in U.S. Pat. No. 7,214,484.
5) The extracted nucleic acids are analyzed for any characteristics that are known to be medically relevant. Methods of analysis are generally well known in the art. The analysis may he, among many others, PCR, gel electrophoresis, DNA sequencing, nucleic acid hybridization, microarray assay, or a combination thereof.
6) The result of the analysis is sent back to the doctor and/or patient in a report. The doctor reads the report and makes an informed judgment as to the patient's risk of developing Lynch Syndrome. If the risk is high, the doctor may suggest measures that can be taken to monitor or postpone the disease development. For example, the doctor may suggest that the patient undergo a colonoscopy more frequently in a closely monitoring mode. If the risk is low, the doctor may not suggest a closely monitoring mode, as frequent colonoscopies would not be cost-effective and the procedure can be uncomfortable and painful in terms of the preparation as well as the procedure itself.

In the case of a customer source, licensees may bring to the attention of the licensing administrator certain genetic diagnostic tests whose related patents should be included in the database. Genetic diagnostic test labs would, for example, in process 127, come to the online store and inquire about patents directed to a specific emerging (or existing) test that is not yet “on the store's shelf,” i.e., not yet offered for license by the store. In this case, in process 129, the licensing administrator will analyze the relevant technologies, perform a patent search, and identify patents that are candidate patents for inclusion in the database.

In the case of the patent owner source, in process 130, candidate patents for genetic diagnostics are directly brought to the attention of the licensing administrator by owners of the candidate patents. This can be in response to a call for patents issued by the licensing administrator. The call for patents can, for example, be communicated in a press release web page that is retrievable as a guest browsing activity from the server A 100 (e.g., in step 117 of FIG. 3). Alternatively, an owner may become aware of the possibility that his/her patent may be useful or essential for a technology pertaining to a license or set of licenses currently offered “in the store,” or for a new genetic test for which no license is currently offered but which has attractive clinical applications.

In step 132, candidate patents from the three sources are studied by business personnel of the licensing administrator and/or patent attorneys to determine their suitability for inclusion in the patent license database. Preferably, the owner of the patent will agree to license the patent under certain terms and conditions of the licensing program. A patent suitable for license will contain claims that read on a component or step in a genetic diagnostic test. Diagnostic tests attractive for inclusion in the database are those having two or more patents covering the components or steps involved in the test, the results of the test are repeatable and clinically valid, the results of the test will improve treatment of a medical condition, and the treatment will impact a significant population or patient's quality of life. If a patent appears suitable for licensing, the patent is evaluated in step 132 by patent attorneys, preferably with experience in the relevant technological field, to determine if the patent is useful or essential for a given test, i.e., whether the patent claims could be read to cover the components or method steps in a given test. If a candidate patent is not evaluated as useful or essential, the patent will not be included in the database 131. If a candidate patent is evaluated as useful or essential, the patent, together with other pertinent information, will be added to the database in step 133. In step 134, the database is updated periodically to eliminate patents that have expired or no longer contain claims covering the subject test, and to add new patents to existing tests, improved tests, or new tests.

### D. Payment Processing Module

FIG. 5 illustrates a payment processing procedure whereby users or customers purchase patent licenses they desire to obtain. In an embodiment, the payment of royalties is preferably processed by an independent outside payment processing service. This outside service is seamlessly integrated with the above purchase process.

In step 138, the processor of the server A 100 retrieves from its disk memory, main memory and/or cache memory, and transfers via its network interface and the Internet to the user's 109 web browser terminal, web pages that enable the user to search for a desired license. The search can be similar to that described above for guest users. Additionally, or alternatively, the user 109 using his or her web browser terminal can input (e.g., using the web browser terminal's input/output device to receive the user's choices and the web browser terminal's network interface to communicate such choices) a designation of a specific desired license without the need to search. Illustratively, the user 109 can choose multiple licenses of interest using the well-known “shopping cart model” used for web based commerce. The signals indicating the user's designations of desired license or licenses are received via the network interface of the server A100 at the processor therein which stores signals representing such choices temporarily in the main memory, disk memory or cache memory.

In response to receiving a request signal from the user's 109 web browser terminal to check out, the processor of the server A 100 transfers instructions to the user's 109 web browser terminal to re-direct the user to an outside payment service website (served by server 106) for payment validation in step 139. The user 109 may provide payment information as before, using the web browser terminal's input/output devices and network interface, such as credit card numbers, PayPal accounts or bank accounts to the payment service website. For reasons of financial safety, this payment information such as credit card numbers, PayPal accounts or bank accounts is not exposed to the licensing administrator's servers 100-104 and 107-108 but only exposed to an outside payment server 106. In step 139, if the payment information is invalid, payment server 106 will transmit to the user's web browser terminal a signal for presentation or display requesting the user to input his or her payment information again. If it is valid, in step 140, the payment will then be directed to a designated bank account of the licensing administrator or another entity chosen by the licensing administrator to receive the payment. Also, in step 141, the outside payment server 106 will send a signal such as a token confirming receipt of the payment to the processor of the server A 100 which is received via its network interface. Upon confirmation of payment, in step 142, the processor of server A 100 will transmit a signal (via its network interface) to the user's web browser terminal for presentation or display requesting the user 109 to report other information (described below) concerning the usage of rights under the patents. In step 143, the processor in server A 100 transfers the reported information via server C 104 to server D 107 and server E 108 for royalty allocation, where such information is checked for accuracy as described below. If the information is inaccurate, the user will be prompted by the server A 100 (i.e., by a signal sent for presentation or display on the user's web browser terminal) to repeat the process, e.g., the reporting step 142. If the information is accurate, the payment process is complete 144 and a signal representing the purchased licenses is transmitted from the server A 100 to the user's 109 web terminal. Such a transmission may be communicated from server A 100 to, and recorded in, server B 103.

Thus, a server operated by or on behalf of the license administrator (namely, server A 100) receives purchase orders and communicates with an outside payment server (namely, server 106) of a financial institution, which obtains payment information, determines the accuracy of payment information, physically processes the payment and returns a confirmation signal to the server A 100. The purchase of licenses and payment of royalties will be part of customer reported information which further includes information about tax withholding. Such customer reported information as a whole will be transmitted to servers A 100 and E 108 for the purposes of royalty allocation.

### E. Royalty Allocation Module

FIG. 6 depicts a royalty allocation process of the invention. The royalty allocation process is generally executed by the internal servers 107 and 108. Royalty pricing may be determined by factors such as the use of a patent in diagnostic tests and methods, the type of claims in the patent (e.g., claiming compositions of matter, apparatus, or processes), effectiveness (clinical validity and utility) of the diagnostic test or method, wholesale effects (whether other companion patent licenses are obtained from the license administrator in “the store,” e.g., in case aggregate discounts are offered), scope of rights to the patents (non-exclusive or exclusive) possessed by the licensing administrator, total cost associated with manufacturing or running the test or method, list price of the diagnostic test or method, percentage of list price reimbursed by insurance companies or government, and total market size for the diagnostic test. For example, the royalty rate might be 3% per licensed patent to a maximum of 20% for tests or methods with prices up to $500. The maximum rate is then reduced 1% per $100 increase in price, reaching 15% for tests or methods with prices of $1000. The maximum rate is further reduced by 1% per $200 increase of test prices, reaching 10% for tests with prices of $2000 and above.

In step 146, the processor in server A 100 receives the user reported information provided in step 143 of FIG. 5. The reported information includes information identifying the licensee, the licensed products to be sold or used by the licensee (e.g., test kit brand name, test service, etc.), royalty statements, tax information and other pertinent information. In step 147, the reported information is checked for its accuracy and completeness by the processor in the server A 100. The license purchase by licensees may require periodic reporting of certain information to the licensing administrator such as the location at which test kits are purchased or sold and/or the location where tests are sold or performed. As an example, the processor in the server A 100 can transfer (via its network interface) a web page prompt to the user's 109 web browser terminal requesting that the user upload a spreadsheet, comma separated value (“CSV”) file or other similar types of files specifying each test licensed and the pertinent country of manufacture, sale and/or use of such test and/or test kit. Responsive to user input via its input/output devices, the user 109 web browser terminal transfers via its network interface such a file to the server A 100 which is received via the network interface of server A 100. The processor of the server A 100 checks the received file against syntax rules (e.g., to determine that values are provided for the respective reported royalties) and business rules (e.g., to determine that entries in the file correspond to licenses that the processor can determine were purchased based on license sale data retrieved from its disk memory, main memory and/or cache memory). Files which meet the syntax and business rules are stored in a disk memory and/or main memory of the appropriate server, e.g., server A 100 and/or server E 108.

Such information is used by the licensing administrator to apportion royalties received from licensees on a country-by-country basis for allocation to licensed patent owners (or their designees) in different countries. For example, consider the situation where the license has 10 U.S. patents and 8 Canadian patents. Suppose also that the patent owners under the respective license have agreed to distribute 50% of paid royalties to patents in force in the country of manufacture of a test kit or individual components for the subject test and 50% of paid royalties to patents in force in the country of use of the test kit or method for the subject test (i.e., where the test is performed). Suppose also that a licensee pays U.S. $800 in royalties for test kits made in Canada which are then used for tests performed in the U.S. Under this scenario, $400 of the royalty payment is distributed on the 10 U.S. patents, e.g., $40 per U.S. patent to the respective U.S. patent holders, and $400 is distributed on the 8 Canada patents, e.g., $50 per Canada patent to the respective Canada patent holders.

If there is inaccuracy or incompleteness in the reported information, the processor A 100 will transfer via its network interface signals prompting the user to repeat all or part of the payment process pertaining to correct royalty reporting (steps 145 and step 142 of FIG. 5) so as to correct the information before the license is transferred to the user. If no issue of inaccuracy and incompleteness exists, the information will be transferred from the server A 100 to the server D 107 to process and to the server E 108 for storage in its disk memory, main memory and/or cache memory.

The processor in the server D 107 will determine whether it is time to update the database in step 148. If it is the end of a database update cycle, the database stored in the disk memory, main memory and/or cache memory of the server E 108 will be updated in step 134, which step is described above in connection with FIG. 4. If it is not the end of database update cycle, or the database is updated in step 134, then in step 149 the processor in the server D 107 will determine if it is time to pay royalties to licensors. Illustratively, royalty payment is also made periodically. The duration of the cycle may be any agreed-on period of time, e.g. one month or three months. If it is not the end of a royalty payment cycle, the server D 107 will return to step 146 and receive more reported information from customers. If it is the end of a royalty payment cycle, then, server D 107 will prepare a settlement statement for each licensor delivery thereto by various means, e.g., electronic mail or regular United States Postal Services mail 150. At the same time, accumulated royalty payments are transferred from server D 107 to licensors by various means such as bank wire transfer 151. To do so, the processor in the server D 107, sends one or more messages to the processor in the server F 108, which cause the server E 108 to retrieve appropriate royalty payment information from its disk memory, main memory or cache memory and transfer such royalty payment information to the processor in server D 107 so that the processor in the server D 107 can perform the royalty calculations and the above mentioned steps 150 and 151.

Illustratively, the server D 107 can be programmed to distribute royalty payments to each licensor or to different third parties as designated by a licensor. For example, a licensor can request that royalties the licensor is to receive that originate from a particular licensee should be refunded to that licensee. The licensor could even more particularly direct that its royalty income originating from that licensee for a specified particular country (or countries) should be refunded to that licensee. For example, under activity 123 (FIG. 3), the licensor can provide instructions to server A 100 indicating such very specific third party payment instructions, which arc transferred to, and stored in, server E 108. The server D 107 can then calculate an appropriate division of that licensor's royalty into appropriate shares, i.e., calculate the correct amount of royalty attributable to the designated countries and originating from the designated licensee, and the remaining royalty, and transfer each share to the respective licensor or designated licensee.

The royalty allocation process can include a number of calculations. First, the processor in the server D 107 may first deduct from royalties collected and matched to licensee reports, the licensing administrator's fee. Next, the processor in the server D 107 can set aside a certain amount of the collected and matched royalties for transfer into one or more funds. For example, the licensors can agree to set aside some collected royalties to fund litigation and other enforcement proceedings against infringers. The licensors can also agree to set aside some collected royalties to reimburse the licensing administrator's activities and costs associated with licensee audits and breach of license contract actions. Also, the licensors can agree to set aside some collected royalties to cover insurance.

In some other situations, the licensors can agree that those of the licensors who have agreed to enforce their patents should obtain a certain stream of royalties before the remainder of the royalties are distributed according to a default pre-agreed allocation formula. For example, suppose that there are X U.S. patent holders who contribute their patents to the store. Y (Y≦X) U.S. patent holders agree to sue an infringer for patent infringement in the U.S. To provide incentive to U.S. patent holders to agree to assert their patents, the licensors can agree that the first Z amount of royalty dollars collected at the conclusion of the infringement action should be paid first to the Y U.S. patent holders upon the conclusion of the infringement action. Afterward, royalties collected over and above the first Z dollars are allocated according to the default pre-agreed allocation formula.

The royalty allocation system may store the history of previous royalty statements and actual disbursements to patent owners or licensors, and, based on such history, may also make projections of future royalty payments for each licensor. In addition, the ability of this allocation system to project future royalty payments may also serve as the basis for estimating the market value of a patent if the license of the patent is one of a set of patent licenses, which set is expected to be purchased by prospective licensees. For example, projections can analyze one or more of the following items stored in the database module: subject matters claimed in the patent, the clinical validity and utility of the genetic tests for which certain patents are licensed, the market size of the genetic tests, the composition of the particular set of patent licenses (number of patents in the set and the relative contribution of each patent to the marketed technology), the expiration dates of the patents in the set, the enforcement history of the patents, the countries in which the patents are in force, the types of claims in the patents, as well as other factors pertinent to royalty allocations as mentioned above.

Illustratively, users 109 who are licensors can log onto the system and obtain different kinds of reporting information regarding royalty payments. Such information would be returned as a web page in accordance with the activity 122 (FIG. 3). For example, a licensor can retrieve: (1) historical royalty payments to that licensor; (2) projection information mentioned above regarding the licensor's own patents; (3) information on the number of ongoing audits by the licensing administrator and royalty underpayments discovered, etc.

The system described herein can support many arrangements among the licensors and licensing administrator and can be used to license and manage patents under such varied arrangements. For example, the system, can be used to license/manage patents in an arrangement in which the licensors grant the licensing administrator nonexclusive licenses under the managed/licensed patents, with the right to grant non-exclusive licenses to any inquiring licensee. Alternatively, one or more licensors can grant exclusive licenses, or exclusive licenses for one or more fields of use, under one or more patents to the licensing administrator, which the licensing administrator then licenses/manages using the system according to the invention. Finally, patent owners can outright sell or assign the rights in one or more patents and patent applications to the licensing administrator. The licensing administrator can then license/manage such purchased patents and patent applications using the system. In such a case, the licensing administrator can combine its automated patent docketing system which tracks office actions and other events associated with such purchased issued and pending patents with information provided by the system according to the invention. Several patent docketing system are available such as PATTSY®.

The system can also be designed to keep track of maintenance fees and annuities and to automatically issue reports to patent offices or annuity payment services requesting them to pay maintenance fees and annuities at the appropriate time (e.g., under any of the arrangements described above).

Although the invention has been described in detail for the purpose of illustration, it is to be understood that such detail is solely for that purpose and that variations can be made by those skilled in the art without departing from the spirit and scope of the invention, except as it may be limited by the issued claims.

What is claimed is:

1. A method for managing patent licenses comprising the steps of:
storing in a first memory location a signal representing a plurality of patent licenses available for procurement,
receiving via a network interface a signal from a user designating at least one of said licenses for procurement,
using a processor, processing a procurement transaction by which said user procures said at least one designated license,
storing in a second memory location a signal representing information pertinent to said procurement transaction including information regarding an identity of said user and information regarding said procured license.

2. The method of claim 1, further comprising the steps of:
storing in a third memory location information indicating each licensable patent for which a patent license is available,
receiving from a user via a network interface a signal containing a request o retrieve a list of one or more of said licensable patents,
using a processor, retrieving from said third memory location said list of licensable patents specified in said request and formatting a signal indicating said retrieved list, and
transmitting to said user via a network interface said formatted signal.

3. The method of claim 1, further comprising the steps of:
storing in a third memory location information indicating each predetermined license for licensing said licensable patents for particular products,
receiving from a user via a network interface a signal containing a query specifying a particular product or a particular category of products to be searched,
using a processor, retrieving from said third memory location each predetermined license available for the product or category of products specified in said query and formatting a signal indicating said retrieved license or licenses, and
transmitting to said user via a network interface said formatted signal.

4. The method of claim 1, further comprising the steps of:
storing in a third memory location information regarding payments for procured licenses,
at a time for distributing royalties to at least one party, using a processor to retrieve from said third memory location at least part of said information regarding payments for procured licenses for particular patents, and
calculating in a processor a royalty to be distributed to a particular one of said at least one parties.

5. The method of claim 4, wherein, if a portion of royalties are to be distributed first to parties on certain patents owned by owners who participated in a litigation, then only calculating a royalty to be distributed on said certain patents and not other patents.

6. The method of claim 4, further comprising the steps of:
preparing in a processor, a royalty statement for said particular at least one party, and
transferring via a network interface a royalty payment according to said calculation.

7. The method of claim 6, wherein said party is different from, but designated by, a licensor of one of said particular patents.

8. The method of claim 1, wherein at least one patent is licensed to a licensing administrator on a nonexclusive basis and wherein one of said patent licenses available for procurement grants a license on said at least one patent licensed to said licensing administrator on a nonexclusive basis.

9. The method of claim 1, wherein at least one patent is licensed to a licensing administrator on an exclusive basis and wherein one of said patent licenses available for procurement grants a license on said at least one patent licensed to said licensing administrator on a nonexclusive basis.

10. The method of claim 1, wherein at least one of said licensable patents covers at least one component or step in a diagnostic test or methodology based on the detection of a biomarker.

11. The method of claim 10, wherein the biomarker is a genetic biomarker.

12. The method of claim 11, wherein said at least one of said licensable patents covers at least one of an isolated nucleic acid, a reagent, or a kit.

13. A method for managing patent licenses comprising the steps of:
storing in a first memory location a signal representing a plurality of patents for which a license is available,
receiving from a user via a network interface a signal designating at least one of said licensable patents,
using a processor, processing a procurement transaction by which said user procures a license for said at least one designated licensable patent, and
storing in a second memory a signal representing information pertinent to said procurement transaction including information regarding an identity of said user and information regarding said procured license.

14. A method for managing patent licenses comprising:
transmitting to a server via a network interface a signal containing a request to retrieve a list of one or more licensable patents for which a license is available,
receiving from said server via a network interface a formatted signal indicating said list of licensable patents specified in said request
using an input/output device, selecting at least one licensable patent on said received list for which a user desires to procure a license, and
transmitting to said server via a network interface a signal requesting procurement of a license for said selected at least one licensable patent.

15. A method for managing patent licenses comprising:
transmitting to a server via a network interface a signal containing a query specifying a particular product or a particular category of products to be searched,
receiving from said server via a network interface a formatted signal indicating each predetermined license available for the product or category of products specified in said query,
using an input/output device, selecting at least one of said predetermined licenses that a user desires to procure, and
transmitting to said server via a network interface a signal requesting procurement of said selected at least one predetermined licenses.

16. A system for managing patent licenses comprising
at least one memory including a first memory location for storing a signal representing a plurality of patent licenses available for procurement,
at least one network interface for receiving a signal from a user designating at least one of said licenses for procurement, and
at least one processor for processing a procurement transaction by which said user procures said at least one designated license,
wherein said at least one memory further comprises a second memory location for storing a signal representing information pertinent to said procurement transaction including information regarding an identity of said user and information regarding said procured license.

17. The system of claim 16 wherein:
said at least one memory further comprises a third memory location for storing information indicating each licensable patent for which a patent license is available,
said at least one network interface is also for receiving from a user a signal containing a request to retrieve a list of one or more of said licensable patents,
said at least one processor is also for retrieving from said third memory location said list of licensable patents specified in said request and for formatting a signal indicating said retrieved list, and
said at least one network interface is also for transmitting to said user said formatted signal.

18. The system of claim 16 wherein:
said at least one memory further comprises a third memory location for storing information indicating each predetermined license for licensing said licensable patents for particular products,
said at least one network interface is also for receiving from a user a signal containing a query specifying a particular product or a particular category of products to be searched,
said at least one processor is also for retrieving from said third memory location each predetermined license available for the product or category of products specified in said query and for formatting a signal indicating said retrieved license or licenses, and
said at least one network interface is also for transmitting to said user said formatted signal.

19. The system of claim 16 wherein:
said at least one memory comprises a memory location for storing information regarding payments for procured licenses, and
at a time for distributing royalties to at least one party, said at least one processor is also for retrieving at least part of said information regarding payments for procured licenses for particular patents, and for calculating a royalty to be distributed to a particular one of said at least one parties.

20. The system of claim 19, wherein, if a portion of royalties are to be distributed first to parties on certain patents owned by owners who participated in a litigation, then said at least one processor is for calculating a royalty to be distributed on said certain patents and not other patents.

21. The system of claim 19, wherein:
said at least one processor is also for preparing a royalty statement for said particular at least one party, and
said at least one network interface is also for transferring a royalty payment according to said calculation.

22. The system of claim 21, wherein said party is different from, but designated by, a licensor of one of said particular ones of said patents.

23. The system of claim 16, wherein at least one patent is licensed to a licensing administrator on a nonexclusive basis and wherein one of said patent licenses available for procurement grants a license on said at least one patent licensed to a licensing administrator.

24. The system of claim 16, wherein at least one patent is licensed to a licensing administrator on an exclusive basis and wherein one of said patent licenses available for procurement grants a license on said at least one patent licensed to a licensing administrator.

25. The system of claim 16, wherein at least one of said licensable patents covers at least one component or step in a diagnostic test or methodology based on the detection of a biomarker.

26. The system of claim 25, wherein the biomarker is a genetic biomarker.

27. The system of claim 26, wherein said at least one of said licensable patents covers at least one of an isolated nucleic acid, a reagent, or a kit.

28. A system for managing patent licenses comprising:
at least one memory comprising a first memory location for storing a signal representing a plurality of patents for which a license is a available,
at least one network interface for receiving from a user a signal designating at least one of said licensable patents, and
at least one processor for processing a procurement transaction by which said user procures a license for said at least one designated licensable patents,
wherein said at least one memory further comprises a second memory location for storing a signal representing information pertinent to said procurement transaction including information regarding an identity of said user and information regarding said procured license.

29. A system for managing patent licenses comprising:
a network interface for transmitting to a server a signal containing a request to retrieve a list of one or more licensable patents for which a license is available, and for receiving from said server a formatted signal indicating said list of licensable patents specified in said request, and
an input/output device for selecting at least one licensable patent on said received list for which a user desires to procure a license,
wherein said network interface is also for transmitting to said server a signal requesting procurement of a license for said selected at least one licensable patent.

30. A system for managing patent licenses comprising:
a network interface for transmitting to a server a signal containing a query specifying a particular product or a particular category of products to be searched, and for receiving from said server a formatted signal indicating each predetermined license available for the product or category of products specified in said query, and
an input/output device for selecting at least one of said predetermined licenses that a user desires to procure,
wherein said network interface is also for transmitting to said server a signal requesting procurement of said selected at least one predetermined licenses.

31. A method for performing a test comprising the steps of:
communicating via a communication network a signal with a remote server that stores one or more licenses under one or more patents, which licenses are offered for testing samples to determine the presence or absence of at least one composition of matter, and
executing a transaction via the communication network with the remote server to obtain one or more licenses under one or more of the patents.

32. The method of claim 31, further comprising the steps of:
obtaining a sample, and
analyzing the obtained sample for the presence or absence of said at least one composition of matter.

33. The method of claim 31 wherein said composition of matter is a biomarker.

34. The method of claim 33, wherein the sample is a bodily sample and the biomarker is selected from the group consisting of mutations of a gene or a panel of genes, over-expression of a gene or a panel of genes, under-expression of a gene or a panel of genes, alternative production of splice variants of a gene or a panel of genes, gene copy number variants, epigenetic nucleic acid modifications, single nucleotide polymorphisms, chromosomal rearrangements, proteins, lipids, metabolites, a labeled compound, a drug by-product, a cellular physiological phenotype, an organ physiological phenotype, a general physiological phenotype, and an image of a cell, an organ or an individual, and combinations of any of the foregoing.

35. The method of claim 34, wherein the sample is a bodily sample and the biomarker is selected from the group consisting of mutations of a gene or a panel of genes, over-expression of a gene or a panel of genes, under-expression of a gene or a panel of genes, alternative production of splice variants of a gene or a panel of genes, gene copy number variants, epigenetic nucleic acid modifications, single nucleotide polymorphisms, chromosomal rearrangements, and combinations of any of the foregoing.
